(19) United States
(12) Patent Application Publication
(10) Pub. No.: US 2022/0004987 A1
(43) Pub. Date: Jan. 6, 2022

(54) ELECTRONIC APPARATUS AND OPERATION METHOD THEREOF

(71) Applicant: Coupang Corp., Seoul (KR)

(72) Inventors: Jae Bong Sung, Seoul (KR); Ro Woon Lee, Seoul (KR); Xiufang Zhu, Seoul (KR); Guofu Liu, Seoul (KR); Xingzhu Gu, Seoul (KR); Hye Leen Choi, Seoul (KR); Yul Hee Lee, Seoul (KR); Sung Han Kim, Seoul (KR)

(21) Appl. No.: 17/022,587

(22) Filed: Sep. 16, 2020

(30) Foreign Application Priority Data
Jul. 3, 2020 (KR) 10-2020-0082254

(51) Int. Cl. G06Q 10/08

(52) U.S. Cl. CPC G06Q 10/08355; G06Q 10/0833; G06Q 10/0838

(57) ABSTRACT

A method for allocating routes to a courier based on first information on or regarding a desired delivery area and a desired delivery quantity and second information on items classified for each route, and an electronic apparatus therefor are provided.

### BACKGROUND

### Technical Field

The present disclosure relates to an electronic apparatus for allocating items to be delivered to couriers and a method of operating the same.

### Description of the Related Art

Items to be delivered to customers upon order may be stored in a fulfillment center or a camp site, and couriers arriving at the fulfillment center or the camp site may deliver the items to customers. Not only the quantity of the items stored in the fulfillment center or the camp site is unpredictable and variable, but also the number of couriers can be variable. Accordingly, there is a need to more accurately and efficiently allocate items to couriers.

Particularly, when the couriers are irregular couriers rather than full-time couriers, the number of couriers may change at any time, so there is a need to allocate items to couriers in real time.

### SUMMARY

### Technical Goals

The disclosed embodiments are intended to disclose an electronic apparatus and a method of operating the same. The technical problems to be solved by the present embodiment are not limited to the technical problems as described above, and other technical problems may be inferred from the following embodiments.

### Technical Solutions

According to the first embodiment, an operation method of an electronic apparatus includes: identifying first information on or regarding a desired delivery area and a desired delivery quantity of each of a plurality of couriers, and second information on items classified for each route; allocating at least some routes among a plurality of routes to at least some couriers among the plurality of couriers based on the first information and the second information; and transmitting information on different routes allocated to each of the at least some couriers to a terminal of each of the at least some couriers.

According to the second embodiment, an electronic apparatus includes: a controller configured to identify first information on a desired delivery area and a desired delivery quantity of each of a plurality of couriers, and second information on items classified for each route, and allocate at least some routes among a plurality of routes to at least some couriers among the plurality of couriers based on the first information and the second information; and a communication device configured to transmit information on different routes allocated to each of the at least some couriers to a terminal of each of the at least some couriers.

According to the third embodiment, a computer readable recording medium includes a non-transitory recording medium on which a program for executing the above-described method on a computer is recorded.

Details of other embodiments are included in the detailed description and drawings.

### Effects

According to the present disclosure, an electronic apparatus may allocate at least some routes to at least some couriers based on first information on a desired delivery area and a desired delivery quantity of each courier and second information on items classified for each route, thereby allocating items more efficiently to couriers. In particular, the electronic apparatus may allocate routes to couriers in real time, which may be more suitable for allocating items to irregular couriers, rather than full-time couriers.

In addition, the electronic apparatus may decrease the desired delivery quantity of the couriers to a predetermined rate in order to allocate routes to more couriers, and may increase the desired delivery quantity of the couriers to allocate more routes to the couriers. Accordingly, the items can be more effectively allocated to the couriers.

In addition, the electronic apparatus allocates routes to the couriers in further consideration of the information on a delivery history of the couriers, thereby allocating the items to the couriers more effectively. For example, the electronic apparatus preferentially allocates a route corresponding to a desired delivery area to a courier who has applied for a delivery work after a long time, so that the courier who performs a delivery work after a long time can handle the delivery task more easily. Therefore, the courier pool can be effectively maintained.

Effects of the invention are not limited to the effects mentioned above, and other effects not mentioned will become apparent to those skilled in the art from the description of the claims.

### BRIEF DESCRIPTION OF THE DRAWINGS

FIG. 1 illustrates a system for delivery of items according to an embodiment.

FIG. 2 illustrates an embodiment of a fulfillment center and a camp site.

FIG. 3 illustrates an embodiment of a method of operating an electronic apparatus.

FIG. 4 illustrates an embodiment of a method in which an electronic apparatus and a terminal operate.

FIG. 5 illustrates an embodiment in which the electronic apparatus filters couriers and items for item allocation.

FIG. 6 illustrates an embodiment in which an electronic apparatus allocates items to a courier.

FIG. 7 illustrates an embodiment in which the electronic apparatus displays information on or regarding a courier to which a route is allocated.

FIG. 8 illustrates a block diagram of an electronic apparatus.

### DETAILED DESCRIPTION

The terminology used in the embodiments has been selected from the general terms that are currently widely used as possible while considering functions in the present disclosure, but this may be changed according to the intention of a person skilled in the art, precedents, the emergence of a new technology, and the like. Also, in certain cases, some terms are arbitrarily selected by the applicant, and in this case, their meanings will be described in detail in the corresponding description. Therefore, the terms used in the present disclosure should be defined based on the meaning of the terms and the contents of the present disclosure, not simply the names of the terms.

Throughout the specification, when a part is said to “include” a component, this means that other components may be further included rather than excluding other components, unless specifically stated otherwise. In addition, terms such as “ . . . unit” and “ . . . module” described in the specification mean a unit that processes at least one function or operation, which can be implemented by hardware or software or by combination of hardware and software.

Throughout the specification, the expression of “at least one of a, b, and c” can include “a only”, “b only”, “c only”, “a and b”, “a and c”, “b and c”, or “all of a, b, and c”.

The “terminal” mentioned below may be implemented as a computer or a portable terminal capable of accessing a server or another terminal through a network. Herein, the computer includes, for example, a laptop or a desktop equipped with a web browser, and the portable terminal is, for example, a wireless communication device that guarantees portability and mobility, which may include all kinds of handheld-based device such as smartphones, tablets, and the like based on wireless communication such as International Mobile Telecommunication (IMT), Code Division Multiple Access (CDMA), W-Code Division Multiple Access (W-CDMA), Long Term Evolution (LTE), and so on.

Hereinafter, exemplary embodiments of the present disclosure will be described in detail with reference to the accompanying drawings so that those skilled in the art to which the present disclosure pertains can easily carry out the embodiments. However, the present disclosure may be implemented in various different forms and is not limited to the embodiments described herein.

In the following, embodiments of the present disclosure will be described in detail with reference to the drawings.

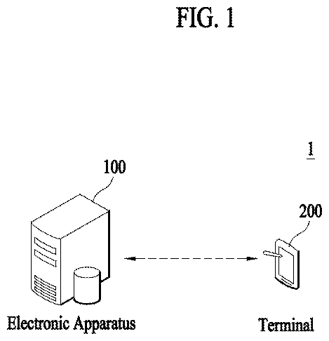

FIG. 1 illustrates a system for delivery of items according to an embodiment.

Referring to FIG. 1, a system 1 for delivery of items may include an electronic apparatus 100 and a terminal 200. In the system 1 shown in FIG. 1, only the components related to this embodiment are shown. Therefore, it can be understood by those of ordinary skill in the art related to this embodiment that components other than those illustrated in FIG. 1 may be further included.

The electronic apparatus 100 and the terminal 200 may communicate with each other within a network. The network includes a local area network (LAN), a wide area network (WAN), a value added network (VAN), a mobile radio communication network, a satellite communication network, and combinations thereof. In addition, it is a comprehensive data communication network that allows each network component to communicate smoothly with each other, and may include wired Internet, wireless Internet, and mobile wireless communication networks. Wireless communication is, for example, wireless LAN (Wi-Fi), Bluetooth, Bluetooth low energy, Zigbee, WFD (Wi-Fi Direct), UWB (ultra-wideband), infrared communication (IrDA, infrared data association), NFC (Near Field Communication), and the like, but is not limited thereto.

The electronic apparatus 100 may manage inventory of items at a camp site. Specifically, items for delivery according to customer's orders may be stored in a camp site, and the electronic apparatus 100 may store information regarding such inventory in a database. For example, the electronic apparatus 100 may store information regarding the location, status, or quantity of each item in a database. In addition, the electronic apparatus 100 may monitor the information on or regarding the inventory, and update information on the inventory when a change occurs in the inventory. For example, when the quantity of an item is changed due to delivery, the electronic apparatus 100 may update information regarding inventory. Also, the electronic apparatus 100 may manage and control the overall situation in which the delivery of items is performed. The electronic apparatus 100 may manage the items delivered from the fulfillment center and stored at the camp site, and allocate the items to the courier so that the items stored at the camp site can be delivered to the customer. For example, when an item is allocated to a courier, the electronic apparatus 100 may allocate an invoice of the item to the courier.

The electronic apparatus 100 may obtain information about a courier from the terminal 200. Specifically, the courier may transmit an application for delivery of items to the electronic apparatus 100 through the terminal 200. For example, the courier may transmit delivery application information including a desired date, a desired time, a desired area, and a desired quantity to the electronic apparatus 100 through the terminal 200. The electronic apparatus 100 may store information on couriers who have applied for delivery, and manage couriers according to the stored information.

The electronic apparatus 100 may divide or classify items on the camp site for each route. Routes can be the criteria for dividing an area or the criteria for dividing a physical space. For example, a route may be set in units of an apartment complex, a building, a floor of a building, or a village as an administrative area, and may be named with a predetermined code. Accordingly, the electronic apparatus 100 may identify each item in the camp site as a route, and each route may include at least one item. In addition, the electronic apparatus 100 may divide a route into a plurality of sub-routes, thereby classifying items in the camp site for each sub-route. For example, when the number of items included in one route is large, the electronic apparatus 100 may divide the route into sub-routes such that one sub-route includes items of a predetermined number or less.

The electronic apparatus 100 may allocate items to the couriers based on the delivery application information of the couriers. Specifically, the electronic apparatus 100 may allocate at least one different item suitable for each of the couriers based on the geographical proximity between the route and the desired delivery area of the courier, and a comparison between the quantity of items the route contains and the desired delivery quantity of the courier. In addition, the electronic apparatus 100 may calculate a load of a delivery operation for each route and/or each sub-route, and may allocate the items to be delivered to a courier in consideration of such workload, delivery date, delivery time, or delivery cost. In addition, the electronic apparatus 100 may allocate items for return of the customer to the couriers based on the delivery application information of the couriers. In this case, the couriers can deliver the allocated items from the customer to the camp site or fulfillment center.

The electronic apparatus 100 may transmit a work command related to delivery to the terminal 200. Specifically, the electronic apparatus 100 may transmit information on the item to the terminal 200 as the item is allocated to the courier. Specifically, the electronic apparatus 100 may transmit the route information of the item, the location of the item being stored, and the delivery destination of the item to the terminal 200. In addition, the electronic apparatus 100 may receive a result of the delivery operation from the terminal 200 and may update information on the item based on the operation result. The terminal 200 may be a terminal carried by the courier.

The electronic apparatus 100 may provide a platform for delivery of items. Specifically, the electronic apparatus 100 may provide an application for item delivery to the terminal 200, and the electronic apparatus 100 may provide a platform for transmitting and receiving information for delivery of items through the terminal 200 connected to the electronic apparatus 100 by executing an application. According to an embodiment, the electronic apparatus 100 may be implemented as a server.

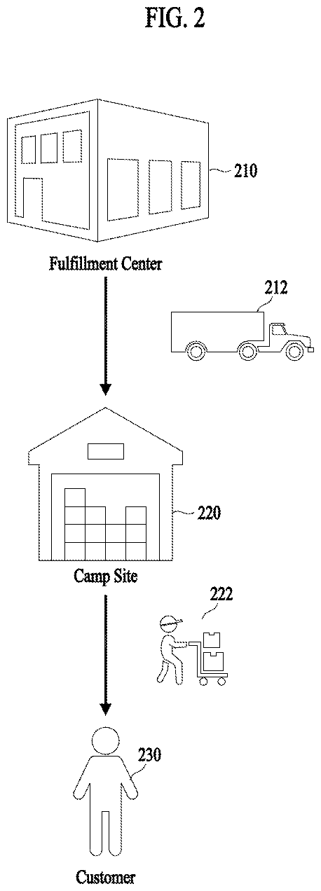

FIG. 2 illustrates an embodiment of a fulfillment center and a camp site.

Items may be classified according to the delivery area in a fulfillment center 210, and delivered to a camp site 220 close to the delivery area. For example, a delivery vehicle 212 may deliver the items of the fulfillment center 210 to the camp site 220.

The camp site 220 may be a site for delivering large quantities of items to the customer 230, and there may be more camp sites 220 than the fulfillment centers 210. The camp site 220 may be located physically closer to the customer 230 than the fulfillment center 210.

According to an embodiment, a courier 222 may deliver an item located at the camp site 220 to the customer 230. Specifically, the courier 222 may be allocated an item to be delivered by the electronic apparatus 100, and may scan the invoice of the allocated item and deliver the item to the customer 230. The courier 222 may be a full-time courier or a flexible or irregular courier who delivers according to needs. According to another embodiment, the courier 222 may be allocated an item to be returned by the electronic apparatus 100, and may scan the invoice of the allocated item and deliver the item from the customer 230 to the camp site 220.

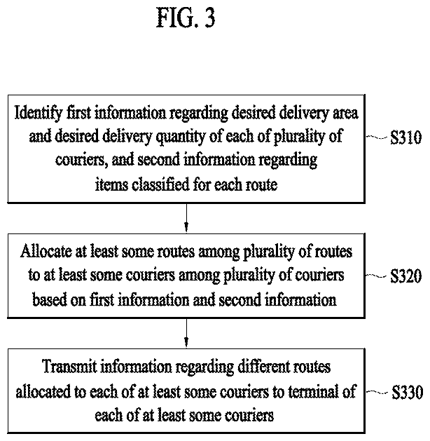

FIG. 3 illustrates an embodiment of a method of operating an electronic apparatus.

In operation S310, the electronic apparatus 100 may identify first information on or regarding a desired delivery area and a desired delivery quantity of each of a plurality of couriers and second information on items classified for each route.

The electronic apparatus 100 may obtain the first information on the desired delivery area and the desired delivery quantity of each of the plurality of couriers from a terminal of each of the plurality of couriers. Specifically, each of the plurality of couriers may transmit a delivery application including the first information on the desired delivery area and the desired delivery quantity to the electronic apparatus 100 through the terminal. The first information may include information on the desired delivery date and the desired delivery time of each of the plurality of couriers. Also, the first information may include information on a delivery history of each of the plurality of couriers. For example, the first information may include information on the number of delivery completion times within a predetermined period of each of the plurality of couriers, and information on the immediately preceding delivery work date of each of the plurality of couriers. In addition, the first information may include information on a desired delivery service type of each of the plurality of couriers. For example, the first information may include information about whether each of the plurality of couriers wishes for a late-night delivery service or a daytime delivery service.

Since the route may be a criterion for dividing an area, the electronic apparatus 100 may classify the items into routes according to the delivery destinations of the items, and identify each of the items with the route. The electronic apparatus 100 may identify second information including information on the items and the route corresponding to each of the items. In addition, when the quantity of items included in one route is equal to or greater than a preset quantity, the electronic apparatus 100 may divide the route into a plurality of sub-routes, and the items may be identified with a route or a sub-route. Therefore, the electronic apparatus 100 may identify the second information including information on the sub-route corresponding to each of the items.

The electronic apparatus 100 may store the first information and the second information in a database. Further, the electronic apparatus 100 may manage each of the plurality of couriers and items based on the first information and the second information.

In operation S320, the electronic apparatus 100 may allocate at least some routes among a plurality of routes to at least some couriers among the plurality of couriers based on the first information and the second information identified in S310.

The electronic apparatus 100 may allocate the at least some routes to the at least some couriers based on geographical proximity between the desired delivery area of each of the plurality of couriers and each of the plurality of routes and comparison between the desired delivery quantity of each of the plurality of couriers and the quantity of items included in each of the plurality of routes. Specifically, the electronic apparatus 100 may allocate at least one route that corresponds to the desired delivery area of the first courier among the plurality of delivery sources and does not exceed the desired delivery quantity of the first courier to the first courier. The electronic apparatus 100 may allocate at least one route to one courier.

When the number of items included in the first route is greater than or equal to the first quantity, the electronic apparatus 100 may divide the first route into a plurality of first sub-routes so that the sub-route includes the second quantity of items and allocate at least one first sub-route to at least one courier of the plurality of couriers. In addition, when the quantity of the items included in the first route is greater than the desired delivery quantity of a specific courier, the electronic apparatus 100 may divide the first route into a plurality of first sub-routes and then allocate the first sub-route to a specific courier.

When two or more routes or sub-routes are allocated to the first courier among the plurality of couriers, the electronic apparatus 100 may allocate geographically adjacent routes or sub-routes to the first courier.

The electronic apparatus 100 may preferentially consider at least one courier whose delivery experience within a predetermined time period is less than a predetermined number of times based on the first information including information on or regarding the delivery history of each of the plurality of couriers to allocate the at least some routes to the at least some of the plurality of couriers including the at least one courier. For example, the electronic apparatus 100 may preferentially consider the desired delivery quantity and the desired delivery area of at least one courier who has no delivery experience within 7 days among the plurality of couriers and allocate at least one route preferentially to the at least one courier.

The electronic apparatus 100 may decrease the desired delivery quantity of each of the plurality of couriers according to a preset rate so that at least one different route can be allocated to more couriers. Specifically, when the total desired delivery quantity of at least some couriers of the plurality of couriers is greater than the total number of items included in the plurality of routes, the electronic apparatus 100 may allocate the plurality of routes to more couriers than the at least some couriers by decreasing the desired delivery quantity of each of the plurality of couriers according to a preset rate. For example, the electronic apparatus 100 may decrease the desired delivery quantity of each of the plurality of couriers within 30%. In addition, in order to allocate routes to more couriers, the electronic apparatus 100 may decrease only the desired delivery quantity of a specific courier to a higher rate than a predetermined rate when the desired delivery quantity of the specific courier is excessive.

The electronic apparatus 100 may increase the desired delivery quantity of each of the plurality of couriers according to a preset rate so that more routes can be allocated to the plurality of couriers. Specifically, when the total desired delivery quantity of the plurality of couriers is less than the total number of items included in at least some routes, the electronic apparatus 100 may allocate more routes than the at least some routes to the plurality of couriers by increasing the desired delivery quantity of each of the plurality of couriers according to a preset rate. For example, the electronic apparatus 100 may increase the desired delivery quantity of each of the plurality of couriers within 10%.

When there is no information on the desired delivery quantity of the first courier among the plurality of couriers in the first information, the electronic apparatus 100 may determine the first quantity based on the number of items and the number of the plurality of couriers as the desired delivery quantity of the first courier. For example, the electronic apparatus 100 may calculate the first quantity by dividing the quantity of the items included in the plurality of routes by the number of the plurality of couriers.

If a route corresponding to the desired delivery area of the first courier of the plurality of couriers is not included in the plurality of routes, the electronic apparatus 100 may allocate a route within a predetermined distance from the desired delivery area of the first courier among the plurality of routes to the first courier.

The electronic apparatus 100 may determine the number of required couriers based on information on items classified for each route, and may select some couriers from among a plurality of couriers who have applied for delivery services according to the determined number of couriers. For example, the electronic apparatus 100 may evaluate a plurality of couriers based on information on the delivery history included in the first information, and select some couriers having high evaluation scores among the plurality of couriers. Accordingly, the electronic apparatus 100 may allocate the plurality of routes to some selected couriers.

In operation S330, the electronic apparatus 100 may transmit information regarding different routes allocated to each of at least some of the couriers to the terminal of each of the at least some couriers. The route information may include at least one of information on a route location and information on at least one item included in the route. The information on the at least one item may include information on the invoice of the item, quantity information of the item, or identification information of the item. Therefore, the courier can confirm the allocated route through the terminal and deliver the items included in the route to the customer.

Therefore, the electronic apparatus 100 may allocate at least some routes to at least some couriers based on the first information on the desired delivery area and desired delivery quantity of each courier, thereby allocating items more efficiently to couriers. In particular, the electronic apparatus 100 may allocate the routes to the couriers in real time, which may be more suitable for allocating items to irregular couriers, rather than full-time couriers.

In addition, the electronic apparatus 100 may decrease the desired delivery quantity of the couriers to a predetermined rate in order to allocate routes to more couriers, and may increase the desired delivery quantity of the couriers to allocate more routes to the couriers. Accordingly, the items can be more effectively allocated to the couriers. For example, the electronic apparatus 100 may effectively maintain a pool of couriers to prevent a situation in which a courier has applied for delivery service but canceled on the same day.

In addition, the electronic apparatus 100 allocates routes to the couriers in further consideration of the information on the delivery history of the couriers, thereby allocating the items to the couriers more effectively. For example, the electronic apparatus 100 preferentially allocates a route corresponding to a desired delivery area to a courier who has applied for a delivery work after a long time, so that a courier who performs a delivery work after a long time can handle the delivery task more easily. Therefore, the courier pool can be effectively maintained.

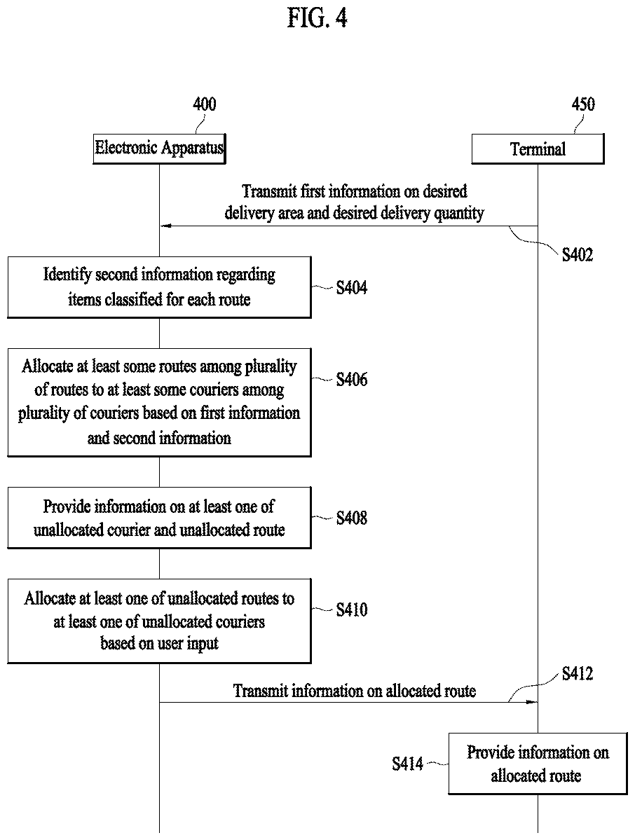

FIG. 4 illustrates an embodiment of a method in which an electronic apparatus and a terminal operate.

In operation S402, a terminal 450 may transmit first information on or regarding a desired delivery area and a desired delivery quantity of a courier to an electronic apparatus 400. Accordingly, the electronic apparatus 400 may obtain the first information on the desired delivery area and the desired delivery quantity of each of a plurality of couriers from the terminal of the plurality of couriers.

In operation S404, the electronic apparatus 400 may identify second information on items classified for each route. In other words, the electronic apparatus 400 may identify second information including information on a route to which each item belongs.

In operation S406, the electronic apparatus 400 may allocate at least some routes among a plurality of routes to at least some couriers among the plurality of couriers based on the first information and the second information. Since S406 may correspond to S320 of FIG. 3, a description of duplicated contents will be omitted.

In operation S408, the electronic apparatus 400 may provide information on at least one of an unallocated courier and an unallocated route. Specifically, the electronic apparatus 400 may recognize the unallocated courier that has not been allocated at least some routes among a plurality of couriers and the unallocated route that has not been allocated to at least some couriers among a plurality of routes. In other words, the electronic apparatus 400 may recognize the unallocated courier of the plurality of couriers other than the at least some couriers and the unallocated route of the plurality of routes other than the at least some routes. According to an embodiment, the electronic apparatus 400 may display information on at least one of the unallocated courier and the unallocated route through a display. For example, the electronic apparatus 400 may display a list of the unallocated courier and a list of the unallocated route through the display.

In operation S410, the electronic apparatus 400 may allocate at least one of the unallocated routes to at least one of the unallocated couriers based on a user input. Specifically, the electronic apparatus 400 may allocate the first route to the first courier upon receiving a user input for matching the first route among the unallocated routes to the first courier among the unallocated couriers. In addition, the electronic apparatus 400 may modify information on a previously allocated courier and route based on a user input. Specifically, the electronic apparatus 400 may display information on the allocated courier and route through the display in S406, and may modify information on the allocated courier and route based on a user input. For example, the electronic apparatus 400 may change the route allocated to the first courier from the first route to the second sub-route based on a user input.

In operation S412, the electronic apparatus 400 may transmit information on the allocated route to the terminal 450. Specifically, the electronic apparatus 400 may transmit information on the route allocated to the courier in S406 and S410 to the terminal 450 of the courier.

In operation S414, the terminal 450 may provide information on the allocated route. For example, the terminal 450 may show the information on the allocated route through the display. Accordingly, the courier can identify the allocated route through the terminal 450 and deliver the items included in the route to the customer.

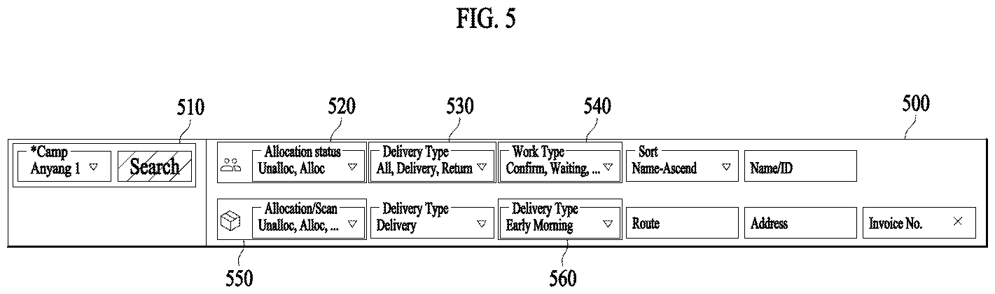

FIG. 5 illustrates an embodiment in which an electronic apparatus filters couriers and items for allocation of items.

The electronic apparatus 100 may filter items or couriers to which the items and invoices of the items are to be allocated. The electronic apparatus 100 may implement a graphics user interface (GUI) for filtering items and couriers.

Referring to FIG. 5, the electronic apparatus 100 may display a page 500 for filtering items and couriers on a screen. Specifically, the page 500 may include a menu 510 for selecting a camp site. The electronic apparatus 100 may select a specific camp site based on a user input through the menu 510 and may perform item allocation for the specific camp site.

The page 500 may include a menu 520 for selecting a range of couriers to whom items are to be allocated. The menu 520 may include “All”, “Unallocated”, and “Allocated”. When the user selects “Allocated”, the electronic apparatus 100 may select couriers to whom the items have already been allocated. When the user selects “Unallocated”, the electronic apparatus 100 may select couriers who have not yet been allocated an item. When the user selects “All”, the electronic apparatus 100 may select both of couriers to whom the items have already been allocated and couriers who have not yet been allocated an item.

The page 500 may include a menu 530 for selecting a delivery type of the courier, and the delivery type may be “Delivery to customer”, “Return from customer”, or “All”.

The page 500 may include a menu 540 for selecting a range of couriers according to the work status of the courier. The menu 540 may include “Confirm”, “Waiting”, and “Start”. When the user selects “Confirm”, the electronic apparatus 100 may select the couriers from whom the delivery application was received. When the user selects “Waiting”, the electronic apparatus 100 may select the couriers who have approved among the couriers from whom the delivery application was received. When the user selects “Start”, couriers who have arrived at the camp site can be selected. In addition, the menu 540 may include “Working” and “Completed”. When the user selects “Working”, the electronic apparatus 100 may select couriers who are currently delivering items. When the user selects “Completed”, couriers who have completed delivery of items can be selected.

The page 500 may include a menu 550 for selecting a range of items. The menu 550 may include “Unallocated”, “Allocated”, and “Scan”. When the user selects “Unallocated”, the electronic apparatus 100 may select items that have not been allocated to a courier. When the user selects “Allocated”, the electronic apparatus 100 may select items that have been allocated to a courier. When the user selects “Scan”, the electronic apparatus 100 may select items that have been scanned by a courier.

The page 500 may include a menu 560 for selecting a range of items according to the delivery type. For example, when the user selects “Early morning delivery” through the menu 560, the electronic apparatus 100 may select items to be delivered in the early morning.

Accordingly, the electronic apparatus 100 may select a range of couriers to deliver the items and select a range of items to be delivered by the courier through an input for selecting each menu in the page 500. For example, the electronic apparatus 100 may select a range of temporary couriers who have applied for an irregular delivery service through each menu in the page 500.

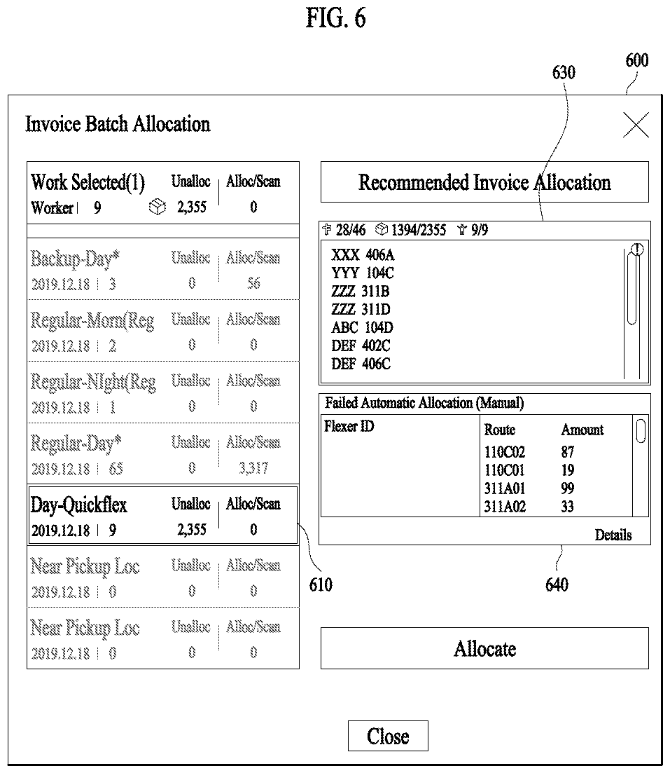

FIG. 6 illustrates an embodiment in which an electronic apparatus allocates items to a courier.

The electronic apparatus 100 may implement a GUI for allocating an item to a courier. Specifically, the electronic apparatus 100 may display a page 600 for allocating an invoice of an item to a courier on a screen.

The page 600 may include a list of works for allocating items, and the user may select a work 610 corresponding to “Day-Quickflex” among them. As the user selects the work 610 and selects the menu “Recommended Invoice Allocation”, the electronic apparatus 100 may allocate at least some routes among the 46 routes (2355 items) to at least some couriers among the nine couriers based on the first information on or regarding the desired delivery quantity and the desired delivery area of the 9 couriers and the second information on the 2355 items classified for each route. Referring to the area 630 in the page 600, the electronic apparatus 100 may allocate 28 routes (1394 items) to 9 couriers. For example, the electronic apparatus 100 may allocate a route corresponding to 406A to a courier corresponding to “XXX”. In addition, referring to the area 640 in the page 600, the electronic apparatus 100 may display information on unallocated routes. According to an embodiment, the electronic apparatus 100 may allocate at least one of unallocated routes to at least one of nine couriers based on a user input. Also, the electronic apparatus 100 may modify information on routes allocated to nine couriers based on a user input. For example, the electronic apparatus 100 may change the route allocated to the courier corresponding to “XXX” from 406A to 110C02.

Accordingly, the electronic apparatus 100 may provide the user with the result of route allocation to the courier, and modify the result based on the user input, so that the items can be allocated more flexibly to the courier.

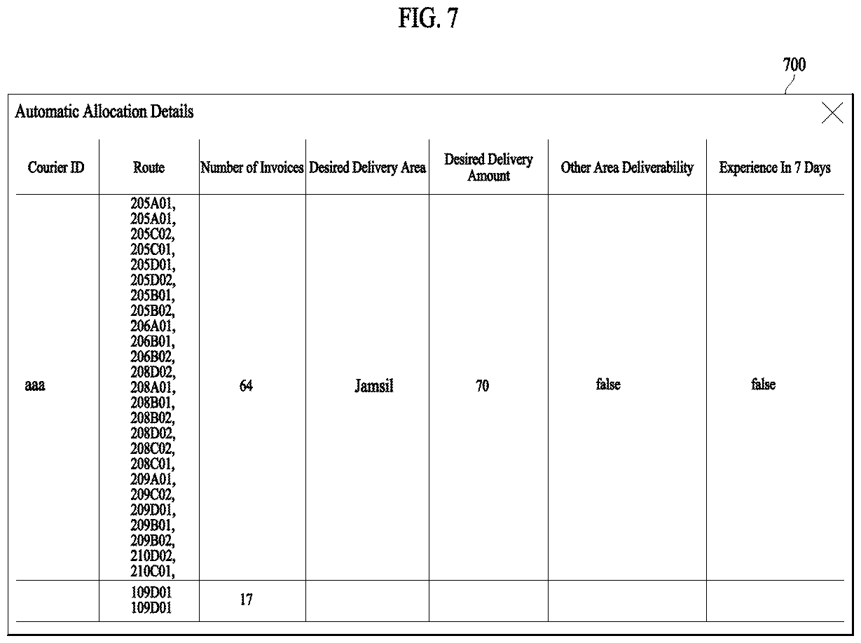

FIG. 7 illustrates an embodiment in which an electronic apparatus displays information on a courier to which a route is allocated.

After the route is allocated to the courier, the electronic apparatus 100 may display a page 700 on a screen according to a user input.

The page 700 may include information on the routes allocated to the courier having a predetermined ID. In addition, the page 700 may include information on the number of invoices of items included in the routes, may include information on the desired delivery area and the desired delivery quantity of the courier, and may include information about whether delivery to an area other than the desired delivery area is possible. Also, the page 700 may include information on whether the courier has experienced delivery in 7 days.

Accordingly, the electronic apparatus 100 displays information on the routes allocated to the courier together with the information related to the delivery application to the courier, so that the user can check whether an appropriate route is allocated to the courier, and may modify or add the route allocated to the courier to ensure that the appropriate route is allocated to the courier.

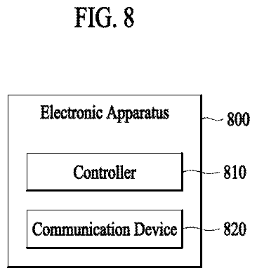

FIG. 8 illustrates a block diagram of an electronic apparatus.

According to an embodiment, an electronic apparatus 800 may include a communication device 820 and a controller 810. In the electronic apparatus 800 illustrated in FIG. 8, only components related to the present embodiment are shown. Accordingly, it can be understood by those of ordinary skill in the art related to the present embodiment that other general-purpose components may be further included in addition to the components shown in FIG. 8. Since the electronic apparatus 800 may include features related to the electronic apparatuses 100 and 400, descriptions of duplicated contents will be omitted.

The communication device 820 is a device for performing wireless communication and may communicate with an external electronic apparatus. The external electronic apparatus may be a terminal or a server. In addition, communication technologies used by the communication device 820 include Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, Near Field Communication (NFC), and the like.

The controller 810 may control the overall operations of the electronic apparatus 800 and may process data and signals. The controller 810 may be configured with at least one hardware unit. Also, the controller 810 may operate by one or more software modules generated by executing program codes stored in the memory. The controller 810 may include a processor and a memory, and the processor may control overall operations of the electronic apparatus 800 and process data and signals by executing program codes stored in the memory.

The controller 810 may identify first information on or regarding a desired delivery area and a desired delivery quantity of each of a plurality of couriers and second information on items classified for each route. The controller 810 may allocate at least some routes among a plurality of routes to at least some of the plurality of couriers based on the first information and the second information.

The controller 810 may allocate the at least some routes to the at least some couriers based on geographical proximity between the desired delivery area of each of the plurality of couriers and each of the plurality of routes and comparison between the desired delivery quantity of each of the plurality of couriers and the quantity of items included in each of the plurality of routes.

The first information may include information on a delivery history for each of the plurality of couriers. The controller 810 may preferentially consider the desired delivery area and the desired delivery quantity of at least one courier whose delivery experience within a predetermined time period is less than a predetermined number of times and allocate the at least some routes to the at least some couriers including the above at least one courier.

The controller 810 may decrease the desired delivery quantity of each of the plurality of couriers according to a preset rate, and allocate the at least some routes to the at least some couriers based on information regarding the decreased desired delivery quantity. If the desired delivery quantity of a first courier exceeds a predetermined quantity, the controller 810 may decrease the desired delivery quantity of the first courier to a higher rate than the preset rate.

The controller 810 may increase the desired delivery quantity of each of the plurality of couriers according to a preset rate and allocate the at least some routes to the at least some couriers based on information regarding the increased desired delivery quantity.

The controller 810 may provide at least one of: information on the at least some couriers, information on the at least some routes, information on unallocated couriers in which the at least some of the couriers are excluded from the plurality of couriers, and information on unallocated routes in which the at least some routes are excluded from the plurality of routes. The controller 810 may show the information through a display.

The controller 810 may receive a user input through an interface, and allocate at least one of the unallocated routes to at least one of the unallocated courier based on the user input. In addition, the controller 810 may modify information on the at least some couriers and the at least some routes based on a user input.

If there is no information on the desired delivery quantity of a first courier among the plurality of couriers in the first information, the controller 810 may determine a first quantity based on the number of items and the number of the plurality of couriers as the desired delivery quantity of the first courier.

If a route corresponding to the desired delivery area of a first courier of the plurality of couriers is not included in the plurality of routes, the controller 810 may allocate a route within a predetermined distance from the desired delivery area of the first courier among the plurality of routes to the first courier.

The controller 810 may obtain information on the desired delivery quantity and the desired delivery area of each of the plurality of couriers from a terminal of each of the plurality of couriers via the communication device 820.

The communication device 820 may transmit information on or regarding different routes allocated to each of at least some of the couriers to each terminal of at least some of the couriers under the control of the controller 810.

The electronic apparatus or terminal according to the above-described embodiments includes a processor, a memory for storing and executing program data, a permanent storage such as a disk drive, a communication port for communicating with an external device, a user interface device such as a touch panel, a key, button, etc. and so on. Methods implemented as software modules or algorithms may be stored on a computer-readable recording medium as computer-readable codes or program instructions executable on the processor. Here, the computer-readable recording medium may include a magnetic storage medium (e.g., read-only memory (ROM), random-access memory (RAM), floppy disk, hard disk, etc.), an optical readable medium (e.g., CD-ROM, and DVD (Digital Versatile Disc)), and the like. The computer-readable recording medium may be distributed over networked computer systems, so that computer-readable codes can be stored and executed in a distributed manner. The medium is readable by a computer, stored in memory, and executed on a processor.

The present embodiment may be represented by functional block configurations and various processing steps. These functional blocks may be implemented with various numbers of hardware and/or software configurations that perform specific functions. For example, the embodiment may employ an integrated circuit configuration such as memory, processing, logic, look-up table, etc., capable of executing various functions by controlling one or more microprocessors or other control devices. Similar to how components can be implemented with software programming or software elements, the present embodiment may be implemented in a programming or scripting language such as C, C++, Java, assembler, or the like including various algorithms implemented with a combination of data structures, processes, routines or other programming components. Functional aspects can be implemented with an algorithm running on one or more processors. In addition, the present embodiment may employ a conventional technique for electronic environment setting, signal processing, and/or data processing. Terms such as “mechanism”, “element”, “means”, and “configuration” can be used in a broad sense, and are not limited to mechanical and physical configurations. The term may include a meaning of a series of routines of software in connection with a processor or the like.

The above-described embodiments are mere examples, and other embodiments may be implemented within the scope of the claims to be described later.

1. A method operable by an electronic apparatus for allocating items to a courier, the method comprising:
maintaining, in real-time, by the electronic apparatus, a variable pool of couriers;
identifying, by the electronic apparatus from the variable pool of couriers, a plurality of couriers associated with a plurality of delivery applications;
identifying, by the electronic apparatus from the plurality of delivery applications, delivery area and a delivery quantity for each of the plurality of couriers and a plurality of items;
classifying, by the electronic apparatus, a plurality of items into a plurality of routes, wherein each route corresponds to one or more items;
causing, by the electronic apparatus, display of a first graphical user interface, wherein the first graphical user interface displays a customizable range of courier statuses of the plurality of couriers and a customizable range of items among the plurality of items;
based on first input received via the first graphical user interface, filtering, by the electronic apparatus, the plurality of couriers and the plurality of items to identify one or more couriers and one or more items, wherein the first input identifies a selection from the customizable range of courier statuses and a selection from the customizable range of items;
allocating, in real time, by the electronic apparatus, one or more routes of the plurality of routes to one or more couriers of the plurality of couriers to generate a recommended allocation, wherein allocating of the one or more routes to the one or more couriers is based on a geographical proximity between a particular delivery area for the one or more couriers and each of the plurality of routes and comparison between a particular delivery quantity for the one or more couriers and a quantity of items for each of the plurality of routes, wherein allocating of the one or more routes comprises:
decreasing the delivery quantity for each of the plurality of couriers according to a preset rate, and
allocating the one or more routes to the one or more couriers based on information regarding the decreased delivery quantity;
causing, by the electronic apparatus, display of a second graphical user interface, wherein the second graphical user interface displays the recommended allocation, wherein the second graphical user interface further displays one or more unallocated routes of the plurality of routes or one or more unallocated couriers of the plurality of couriers based on the recommended allocation;
based on second input received via the second graphical user interface, generating an allocation, wherein the allocation comprises the recommended allocation or an updated allocation based on allocating at least one of the one or more unallocated routes or at least one of the one or more unallocated couriers; and
transmitting, by the electronic apparatus to a terminal associated with a courier of the one or more couriers, a work command for a route allocated to the courier of the one or more routes based on the allocation.

2. (canceled)

3. The method of claim 1, further comprising:
identifying, a delivery history for each of the plurality of couriers, wherein the allocating of the one or more routes to the one or more couriers comprises:
preferentially considering a delivery area and a delivery quantity of at least one courier whose delivery experience within a predetermined time period is less than a predetermined number of times to allocate the one or more routes to the one or more couriers including the at least one courier.

4. (canceled)

5. The method of claim 1, wherein the decreasing of the delivery quantity for each of the plurality of couriers according to the preset rate comprises:
in response to determining a delivery quantity for a first courier exceeds a predetermined quantity, decreasing the delivery quantity for the first courier to a higher rate than the preset rate.

6. The method of claim 1, wherein the preset rate is a first preset rate, wherein the allocating of the one or more routes to the one or more couriers comprises:
increasing the delivery quantity for each of the plurality of couriers according to a second preset rate; and
allocating the one or more routes to the one or more couriers based on information regarding the increased delivery quantity.

7. The method of claim 1, further comprising:
providing at least one of information regarding the one or more couriers, information regarding the one or more routes, information regarding the one or more unallocated couriers, or information regarding the one or more unallocated routes.

8. The method of claim 1, wherein the allocation is further based on allocating the at least one of the one or more unallocated routes to the at least one of the one or more unallocated couriers based on the second input.

9. The method of claim 1, further comprising:
modifying the one or more couriers and the one or more routes based on a third input.

10. The method of claim 1, wherein the allocating of the one or more routes to the one or more couriers comprises:
in response to determining the delivery quantity for each of the plurality of couriers does not include a delivery quantity of a first courier of the plurality of couriers, determining the delivery quantity of the first courier based on a number of the plurality items and a number of the plurality of couriers.

11. The method of claim 1, wherein the allocating of the one or more routes to the one or more couriers comprises:
in response to determining a first route corresponding to a delivery area of a first courier of the plurality of couriers is not included in the plurality of routes, allocating a second route of the plurality of routes within a predetermined distance from the delivery area of the first courier to the first courier.

12. The method of claim 1, wherein the identifying of the delivery area and the delivery quantity for each of the plurality of couriers and the plurality of items comprises:
obtaining information regarding the delivery quantity and the delivery area for each of the plurality of couriers from a particular terminal associated with each of the plurality of couriers.

13. A non-transitory computer readable recording medium on which a program for executing the method of claim 1 on a computer is recorded.

14. An electronic apparatus for allocating items to a courier, the apparatus comprising:
a controller configured to:
maintain, in real-time, a variable pool of couriers;
identify, from the variable pool of couriers, a plurality of couriers associated with a plurality of delivery applications;
identify, from the plurality of delivery applications, delivery area and a delivery quantity for each of the plurality of couriers and a plurality of items;
classify a plurality of items into a plurality of routes, wherein each route corresponds to one or more items;
cause display of a first graphical user interface, wherein the first graphical user interface displays a customizable range of courier statuses of the plurality of couriers and a customizable range of items among the plurality of items;
based on first input received via the first graphical user interface, filter the plurality of couriers and the plurality of items to identify one or more couriers and one or more items, wherein the first input identifies a selection from the customizable range of courier statuses and a selection from the customizable range of items;
allocate, in real time, one or more routes of the plurality of routes to one or more couriers of the plurality of couriers to generate a recommended allocation, wherein allocating of the one or more routes to the one or more couriers is based on a geographical proximity between a particular delivery area for the one or more couriers and each of the plurality of routes and comparison between a particular delivery quantity for the one or more couriers and a quantity of items for each of the plurality of routes, wherein the controller is configured to:
decrease the delivery quantity for each of the plurality of couriers according to a preset rate, and
allocate the one or more routes to the one or more couriers based on information regarding the decreased delivery quantity;
cause display of a second graphical user interface, wherein the second graphical user interface displays the recommended allocation, wherein the second graphical user interface further displays one or more unallocated routes of the plurality of routes or one or more unallocated couriers of the plurality of couriers based on the recommended allocation;
based on second input received via the second graphical user interface, generate an allocation, wherein the allocation comprises the recommended allocation or an updated allocation based on allocating at least one of the one or more unallocated routes or at least one of the one or more unallocated couriers; and
a communication device configured to transmit, to a terminal associated with a courier of the one or more couriers, a work command for a route allocated to the courier of the one or more routes based on the allocation.
